(19) United States
(12) Patent Application Publication
(10) Pub. No.: US 2026/0370147 A1
(43) Pub. Date: Nov. 19, 2026

(54) MODULAR DC-DC CONVERTER

(71) Applicant: Innomotics GmbH, 90441 Nürnberg (DE)

(72) Inventors: VIKTOR HOFMANN, Bayreuth (DE); PATRICK HOFSTETTER, Erlangen (DE)

(73) Assignee: Innomotics GmbH, 90441 Nürnberg (DE)

(21) Appl. No.: 19/135,627

(22) PCT Filed: Aug. 30, 2023
(86) PCT No.: PCT/EP2023/073812

§ 371 Date: Jun. 4, 2025

(30) Foreign Application Priority Data
Dec. 5, 2022 (EP) 22211404.3

(51) Int. Cl. H02M 3/335; H02J 1/08; H02M 3/00

(52) U.S. Cl. CPC H02M 3/33571; H02J 1/08; H02M 3/01; H02M 3/33576

(57) ABSTRACT

The invention relates to a modular DC-DC converter (1) comprising a first DC voltage side (2) with two first DC voltage connections (21, 22), a second DC voltage side (3) with two second DC voltage connections (31, 32), a first module arm (4) with two first module arm connections (7), and a second module arm (5) with two second module arm connections (8). The first module arm (4) and a first inductor (23) are arranged in series between the two first DC voltage connections (21, 22), wherein the second module arm (5) and a second inductor (33) are arranged in series between the two second DC voltage connections (31, 32), wherein the first module arm (4), the second module arm (5) and a mesh capacitor (61) are arranged in series in such a way that a mesh circuit (6) is formed, wherein the module arms (4, 5) are designed to generate a respective voltage (uM1, uM2) having a DC voltage portion and an AC voltage portion with a first frequency (f1). The invention also relates to a DC voltage network (10) with a DC-DC converter (1) of this type. The invention further relates to a method for operating a modular DC-DC converter (1) of this type or a DC voltage network (10) of this type.

The invention relates to a modular DC-DC converter having a first DC voltage side with two first DC voltage terminals and a second DC voltage side with two second DC voltage terminals. The invention also relates to a DC voltage grid with a modular DC-DC converter of this type and a DC voltage source. The invention further relates to a method for operating a modular DC-DC converter of this type or a DC voltage grid of this type.

A DC-DC converter is used to convert a first DC voltage applied at the two first DC voltage terminals of a first DC voltage side into a second DC voltage applied at the two second DC voltage terminals of a second DC voltage side. Electrical energy is transmitted between the first and the second DC voltage side.

DC-DC converters allow DC voltage grids of differing voltage to be connected to one another. The DC-DC converter also makes it possible to connect one or more consumers to a DC voltage grid, wherein consumer and DC voltage grid have different operating voltages.

A DC-DC converter is also referred to as a direct current regulator or a DC-DC chopper.

DC voltage grids are increasingly gaining in importance today against the background of the contemporary technological landscape, They are used in the high-efficiency transmission of large amounts of energy or serve as collector grids for photovoltaic installations or wind energy installations. They are also being used more and more frequently as ship grids or in automotive charging Infrastructure, inter alla also due to the ongoing drive towards decarbonization. The advantages here, for example, include increased efficiency and energy density, a possible reduction in switchgear and passive power components as well as easier integration of batteries or fuel cells. DC-DC converters form an important key technology in the implementation of such grids. These devices for adapting different DC voltages enable equipment to be connected to the grid and allow energy to be exchanged between grids of different voltage levels.

Traditionally, in a DC-DC regulator the DC voltage is converted into an AC voltage. The voltage level is adjusted with the aid of a transformer and then the AC voltage is converted into a DC voltage again by means of a rectifier. Depending on the type of conversion into AC voltage and DC voltage, the DC-DC converter can transmit energy in only one direction or in both directions.

In the text that follows, the term “arranged in series” is used when the individual voltages of the components arranged in series are added together and the sum of these individual voltages is applied as a total voltage across these elements. In addition, these elements do not necessarily have to have the same current flowing through them. A branch for the current can be arranged between the elements. In a series circuit, the components arranged in a series circuit also have the same current flowing through them.

In electrical engineering, a mesh circuit refers to a circuit closed by electrical components or generally by branches. The sum of the voltages across all components or branches of a mesh circuit is always equal to zero.

The invention is based on the object of improving a modular DC-DC converter.

This object is achieved by a modular DC-DC converter having a first DC voltage side with two first DC voltage terminals, a second DC voltage side with two second DC voltage terminals, a first module arm with two first module arm terminals and a second module arm with two second module arm terminals, wherein the first module arm and a first inductor are arranged in series between the two first DC voltage terminals, wherein the second module arm and a second inductor are arranged in series between the two second DC voltage terminals, wherein the first module arm, the second module arm and a mesh capacitor are arranged in series in such a way that a mesh circuit is formed, wherein the first and the second inductor are each arranged outside the mesh circuit, wherein a first number of submodules is arranged in a series circuit between the two first module arm terminals of the first module arm and a second number of submodules is arranged in a series circuit between the two second module arm terminals of the second module arm, wherein the submodules each comprise at least two semiconductor switches and at least one module capacitor, wherein the module arms are each designed to generate a voltage having a DC voltage portion and an AC voltage portion with a first frequency. This object is further achieved by a DC voltage grid with at least one modular DC-DC converter of this type and a DC voltage source, wherein the modular DC-DC converter electrically connects an electrical component to the voltage source, wherein the DC voltage source and the electrical component have different operating voltages. This object is further achieved by a method for operating a modular DC-DC converter of this type or a DC voltage grid of this type, wherein the first module arm and the second module arm each generate a voltage with a DC voltage portion and an AC voltage portion with a first frequency, wherein the DC voltage portion and the AC voltage portion are superimposed in such a way that the respective DC voltage portion and the respective AC voltage portion are applied as a sum between the module arm terminals of the respective module arm.

Further advantageous configurations of the invention can be gathered from the dependent claims.

The invention is based, inter alla, on the discovery that a DC-DC converter can be implemented by two module arms which each generate a voltage that has a DC voltage portion and an AC voltage portion. These voltage portions are superimposed additively, such that in each case the sum of DC voltage portion and AC voltage portion with a first frequency is applied between the respective module arm terminals. Moreover, still further voltage portions can be superimposed on the DC voltage portion and the AC voltage portion. The two AC voltage portions of the two module arms have the same frequency. Power is exchanged between these module arms and thus also between the two DC voltage sides with this frequency.

To distinguish between the different capacitors, they bear the name mesh capacitor for the arrangement in the mesh circuit and module capacitor for the arrangement in the submodule. In one advantageous configuration, a wave trap capacitor is also referred to further below. These designations provide information on the arrangement of the capacitor and do not describe the construction or configuration of the corresponding capacitor.

A direct current flows between the DC voltage terminals of the respective DC voltage side. This direct current can be controlled or regulated by the DC voltage portion of the respective module arm. The DC voltage portion of the first module arm controls or regulates the direct current on the first DC voltage side and the DC voltage portion of the second module arm controls or regulates the direct current on the second DC voltage side, by virtue of a corresponding DC voltage drop being generated across the first or second inductor, by which voltage drop the direct current is controlled or regulated. In addition to the direct current, the power on the respective DC voltage side or the DC voltage can be alternatively or additionally regulated in a superimposed regulating circuit, for example. In the connection of two sub-grids of a DC voltage grid, wherein the sub-grids have different operating voltages, it can be advantageous to control or regulate the exchange of power between the two sub-grids. If one of the sub-grids is a stand-alone grid, it can also be advantageous to control or regulate the voltage of the sub-grid that is formed as a stand-alone grid.

In a simple configuration, the first sub-grid can comprise a DC voltage source and the second sub-grid can comprise an electrical component, such as an electrical consumer, for example. By means of the modular DC-DC converter, it is possible to connect the electrical component to the first sub-grid, in particular to the voltage source of the first sub-grid, even if the DC voltage source and the electrical component have different operating voltages. The modular DC-DC converter in the DC voltage grid adapts the different operating voltages to one another, by transmitting energy from the voltage source with an amended operating voltage to the electrical consumer.

The AC voltage portion is used to transmit electrical energy from the first DC voltage side to the second DC voltage side and vice versa. The first inductor prevents an alternating current from forming between the two first DC voltage terminals of the first DC voltage side. The second inductor prevents an alternating current from forming between the two second DC voltage terminals of the second DC voltage side. Likewise, by means of the first inductor an AC voltage portion is avoided or at least sufficiently suppressed at the first DC voltage terminals, and by means of the second inductor an AC voltage portion is avoided or at least sufficiently suppressed at the second DC voltage terminals.

Energy is exchanged from the first DC voltage side to the second DC voltage side by means of the AC voltage generated by the module arms and an alternating current in the mesh circuit. The AC voltage portions generated by the module arms must have the same frequency for the energy transmission. This frequency is referred to as the first frequency. To prevent a direct current between the first DC voltage side and the second DC voltage side, the mesh capacitor is provided in the mesh circuit. The mesh capacitor can be formed as a unipolar capacitor, for example. This design makes it particularly cost-effective. By means of the AC voltage portions of the two module arms, a voltage can be applied across the mesh capacitor that causes an alternating current and thus brings about a transmission of energy between the DC voltage sides. In order to generate an exchange of active power, it is advantageous when the mesh circuit is behaving purely capacitively, for example, if the AC voltage portion of the first module arm has a phase shift, also referred to as a phase offset, in relation to the AC voltage portion of the second module arm.

For the modular DC-DC converter to be constructed simply and cost-effectively, a first connecting point between the mesh capacitor and the first module arm can be connected to one of the two first DC voltage terminals directly or via the first Inductor. A second connecting point between the mesh capacitor and the second module arm can also be connected to one of the two second DC voltage terminals directly or via the second inductor.

Using the DC-DC converter or several DC-DC converters, that is, at least one DC-DC converter, in a DC voltage grid is particularly advantageous. The DC-DC converter makes it possible to connect components of differing operating voltage in the DC voltage grid. An electrical consumer or energy storage device can be connected to the DC voltage grid via a DC-DC converter. Using the DC-DC converter, it is moreover possible to control or regulate the energy exchange and power between parts of the DC voltage grid.

In one configuration, in which the DC voltage grid has two sub-grids of differing operating voltage, an advantageous configuration is produced if the modular DC-DC converter is connected to the first of the two sub-grids using the first two DC voltage terminals and is electrically connected to the second of the two sub-grids using the second two DC voltage terminals. Energy exchange in both directions between the sub-grids is therefore possible. The sub-grids can have different operating voltages.

In a DC voltage grid, the modular DC-DC converter is generally suitable for connecting an electrical consumer, an energy source or an energy storage device to a sub-grid of the DC voltage grid. The DC voltage grid or the sub-grid can have further consumers, further energy sources and/or energy storage devices. The modular DC-DC converter can provide the electrical consumer, the energy source and/or the energy storage device with the voltage required for operation thereof. In addition, the voltage on the DC voltage side, on which the electrical consumer, the energy source or the energy storage device is connected to the DC voltage terminals of the relevant DC voltage side, can be regulated or controlled. Alternatively, it is possible to control or regulate the electrical power between the sub-grid and the electrical consumer, the energy source and/or the energy storage device by means of the DC-DC converter.

Moreover, the modular DC-DC converter can be used to connect two DC grids with any voltage levels to one another and to enable bidirectional exchange of power. The first DC voltage side can be used as an overvoltage side, for example, while the second DC voltage terminals represent the undervoltage side of the DC-DC converter.

The construction of the DC-DC converter substantially comprises five functional blocks. These include the first inductor, the second inductor, the mesh capacitor, the first module arm and the second module arm. Due to their configuration with a series circuit of submodules, the module arms are also referred to as M2C arms. The module arms have at least one submodule. The submodules are arranged in a series circuit between the two module arm terminals. The term series circuit is also intended to include the case of a submodule which is then connected to the module arm terminals using its terminals. The series circuit can have any number of submodules, that is, it can also have one submodule. In other words, the number of submodules is greater than or equal to one. All known embodiments of submodules are suitable as submodules.

A first design of a submodule has two semiconductor switches and a module capacitor. A zero voltage or the voltage applied at the module capacitor can therefore be provided at the terminals of the submodule. A submodule with four semiconductor switches allows for the provision of the zero voltage, the positive voltage of the module capacitor and the negative voltage of the module capacitor at the terminals of the submodule. The use of several module capacitors allows different capacitor voltages to be provided at the terminals of the submodule.

The variants of the submodule which are mentioned by way of example are also referred to as half-bridge module, full-bridge module and double submodule.

The two module arms, that is, the first module arm and the second module arm, modulate prescribed voltage setpoint values which comprise the DC voltage portion and the AC voltage portion, and can be regarded in simple terms as ideal voltage sources.

In the stationary state, the overvoltage-side DC voltage can be modulated by the first module arm, for example, and the undervoltage-side DC voltage can be modulated by the second module arm. By modulating an additional DC voltage, which leads to a voltage drop across the first inductor or the second inductor, the respective direct current on the first DC voltage side or on the second DC voltage side can be actively regulated. The sum of DC voltage and additional DC voltage forms the DC voltage portion which is generated by the respective module arm.

In order to implement the exchange of energy between the two DC voltage sides of the DC-DC converter and also to ensure there is energy equilibrium at the two module arms, an AC voltage portion is modulated by the two module arms in each case in addition to the DC voltage portion or the DC voltages. The frequency of the AC voltage portion is referred to as the first frequency. This first frequency is the same for the AC voltage portion of the first module arm and the AC voltage portion of the second module arm. As a result of the AC voltage portions, an additional AC voltage is dropped across the mesh capacitor due to the different amplitude and/or phase length of the AC voltage portions in the mesh circuit. This additional AC voltage with the first frequency inserts an alternating current into the mesh circuit. The additional AC voltage can either be generated by one of the two module arms or be distributed as desired over both module arms. The AC voltage portion is therefore composed of an AC voltage that is the same for both module arms and the portion for generating the additional AC voltage. The AC voltages generated by the module arms and the additional AC voltage or additional AC voltages have the same frequency, the first frequency. The sum of AC voltage and the portion for generating the additional AC voltage forms the AC voltage portion which is generated by the respective module arm.

The frequency for the first frequency can be selected as desired. Higher frequencies lead to increased switching losses and conductor losses, but reduce harmonics in particular during the exchange of energy in the module capacitors and the Inductors and the capacitors of the DC-DC converter. The amplitude of the AC voltage portion can also be selected freely or as desired. Due to the necessary energy equilibrium, a high voltage in the AC voltage portion leads to a lower current amplitude in the alternating current and vice versa. To keep the two DC voltage sides free of AC voltages and AC currents, the first inductor is used for the first DC voltage side and the second inductor is used for the second DC voltage side. In a first approximation, the mesh capacitor forms a short-circuit for the alternating current and ensures that the alternating current can be inserted into the mesh circuit and circulates within the mesh circuit. The difference in the voltage applied at the first and second DC voltage terminals is dropped across the mesh capacitor. The first and second inductor are used to suppress the AC voltage portion and the associated alternating currents at the DC voltage terminals of the DC-DC converter. These passive components such as the mesh capacitor, first and second inductor, are dimensioned on the basis of the selected first frequency.

It has been shown that, on the basis of the module capacitor, the additional AC voltage that is used to generate the alternating current is small in comparison with the AC voltage. Therefore, in many applications, the amplitude of the additional AC voltage is less than 10% of the amplitude of the AC voltage.

To ensure that there is energy equilibrium in the DC-DC converter, excluding electrical losses, the electrical powers transmitted on the DC voltage sides by means of DC voltage and direct current are the same as the power transmitted within the mesh circuit by means of alternating current and alternating voltage. This means that, on average, the energy stored in the module capacitors stays the same and, on average, the module capacitors are neither overcharged nor discharged. Furthermore, it becomes clear that the powers on the DC voltage sides are the same. This means that the power that flows into the DC-DC converter on the first DC voltage side flows out on the second DC voltage side of the DC-DC converter, excluding electrical losses of the DC-DC converter. For this reason, it is advisable, for example, to regulate the power transmitted by means of alternating voltage and alternating current on the basis of the voltages of the module capacitors.

As a result of the compensated power balance, energy can be transmitted between the two DC voltage sides.

Active power is not converted in the passive components such as inductors and capacitors.

The proposed circuit for the DC-DC converter offers numerous possibilities for ideal power scaling. Freely selecting the first frequency allows the components used to be utilized in an optimal manner. The possibility of freely adjusting the AC voltage portion and the alternating current in the mesh circuit means that it is possible to optimally adapt the number of submodules to be installed in the module arms to the requirements of the power to be transmitted. The circuit is also capable of handling short-circuits occurring at the DC voltage terminals of one of the DC voltage sides or at both DC voltage sides without disconnecting the DC-DC converter. In other words, these interferences can be passed through on one or both DC voltage sides.

In one advantageous configuration of the invention, a third inductor is arranged in the mesh circuit. The third inductor brings about a smoothing of the current in the mesh circuit. In particular, the alternating current generated by the AC voltage portion within the mesh circuit is smoothed. This alternating current is generated by an additional AC voltage that is applied across the mesh capacitor. The current arises from the change in the voltages across the mesh capacitor. Especially small but rapid changes such as those which occur with pulse width modulation, if the submodules are activated with pulse width modulation, generate high currents. These can be smoothed with the aid of the third inductor in the mesh circuit. As a result, jumps in the alternating current are successfully avoided. In addition, the additional AC voltage of the AC voltage portion, or the difference between the AC voltage portion of the first module arm and the AC voltage portion of the second module arm, is no longer fully applied across the capacitor, but is distributed over mesh capacitor and third inductor. This also leads to the alternating current having a smoothed profile and thus to fewer electrical losses in the DC-DC converter.

If the third inductor, or parts of the third conductor, is arranged in a series circuit with the first module arm and/or second module arm, the third inductor or the corresponding parts of the third inductor also brings about a smoothing of the direct current at the DC voltage terminals of the DC-DC converter. Moreover, interfering effects of the AC voltage at the DC voltage terminals are further reduced and suppressed.

In a further advantageous configuration of the invention, the first frequency is greater than a series resonant frequency that arises from the mesh capacitor and the third inductor. With the mesh capacitor, the third inductor forms a series resonance circuit with a series resonant frequency. This series resonance circuit is formed regardless of where the third inductor is arranged in the mesh circuit. This series resonance circuit has a synergistic effect. On one hand, the mesh capacitor furthermore prevents a direct current between the first and the second DC voltage side of the DC-DC converter. If the first frequency of the AC voltage portion is selected to be greater than the series resonant frequency or if the series resonant frequency is selected to be less than the first frequency by appropriately dimensioning the third inductor and the mesh capacitor, the impedance of the mesh circuit acquires an inductive behavior for the first frequency. Therefore, the alternating current is dependent on the integral of the AC voltage applied across this series resonance circuit. The AC voltage applied across the series resonance circuit corresponds to the additional AC voltage or the difference between the AC voltage portion of the first module arm and the AC voltage portion of the second module arm. The inductive behavior not only produces strong smoothing of the alternating current in the mesh circuit. Moreover, the alternating current is significantly simpler to control and regulate, because it is dependent on the integral of the abovementioned difference between the AC voltage portion of the first module arm and the AC voltage portion of the second module arm and no longer dependent on the derivative, as would be the case with a capacitive behavior. This simplifies regulation and prevents high current peaks within the modular DC-DC converter.

In a further advantageous configuration of the invention, the third inductor is formed at least partially by a first module arm inductor in the first module arm and a second module arm inductor in the second module arm. The third inductor does not necessarily have to be implemented by an individual component part such as a coll. There is the possibility of implementing the third inductor with inductive behavior by means of two, three or even more elements.

One part of the third inductor which is arranged in a series circuit with the first module arm, and therefore also has the same current flowing through it that is also flowing through the first module arm, is referred to as the first module arm inductor. A further or remaining part of the third inductor which is in a series circuit with the second module arm, and therefore also has the same current flowing through it that is also flowing through the second module arm, is referred to as the second module arm inductor.

The first module arm Inductor and the second module arm inductor with the mesh capacitor produce the above-described series resonance circuit with the advantages mentioned. Moreover, they improve the regulating behavior of the direct currents and suppress or reduce the effects of the AC voltage portion of the module arms on the respective DC voltage side of the DC-DC converter.

In a further advantageous configuration of the invention, a first wave trap capacitor is arranged in parallel with the first inductor or with part of the first inductor and/or a second wave trap capacitor is arranged in parallel with the second inductor or part of the second inductor. To reduce the interfering influence of the AC voltage portion and of the associated alternating current in the mesh circuit on the first DC voltage side and/or the second DC voltage side, it has proven advantageous to extend the first inductor and/or the second inductor with a capacitor, referred to as a wave trap capacitor, in a parallel circuit in such a way that a wave trap is produced. A wave trap ideally has an infinite impedance for the wave trap resonant frequency. With the aid of the wave trap or wave traps, the effects of the AC voltage portions of the first module arm and/or the second module arm on the DC voltage sides, in particular on the voltage applied between the first DC voltage terminals and between the second DC voltage terminals, can be further reduced, sometimes even completely eliminated.

In addition, the first wave trap capacitor does not necessarily have to be connected in parallel with the entire first inductor. It is also sufficient to arrange only part of the first inductor in parallel with the first wave trap capacitor. It is therefore possible to specify the wave trap resonant frequency without changing the dimensions of the component parts, in particular of coll and capacitor. The same is analogously true for the second inductor and the second wave trap capacitor.

In a further advantageous configuration of the invention, the first wave trap capacitor is arranged in parallel with the first inductor and the second wave trap capacitor is arranged in parallel with the second inductor, wherein a first wave trap resonant frequency, which arises from the parallel circuit of the first inductor and the first wave trap capacitor, is of the same order of magnitude as, in particular is identical or at least almost identical to, the second wave trap resonant frequency which arises from the parallel circuit of the second inductor and the second wave trap capacitor. The same order of magnitude is understood to mean that the variables which are of the same order of magnitude differ by no more than a factor of 10. Almost identical is understood to mean that two almost identical variables differ by no more than 1%. The task of the first inductor and the first wave trap capacitor and of the second and the inductor and the second wave trap capacitor is to reduce or eliminate the effects of the AC voltage portion on the DC voltage sides. Since the AC voltage portion of both module arms has the same frequency, the first frequency, it is advantageous to size or dimension the first inductor, the second inductor, the first wave trap capacitor and the second wave trap capacitor in such a way that the first wave trap resonant frequency and the second wave trap resonant frequency are of the same order of magnitude, are almost identical or are identical. To suppress the abovementioned effects, it has proven particularly advantageous to provide the first frequency for the first wave trap resonant frequency and the second wave trap resonant frequency. The first wave trap resonant frequency and the second wave trap resonant frequency are then identical or at least almost identical to the first frequency.

In a further advantageous configuration of the invention, the series resonant frequency is less than at least one of the wave trap resonant frequencies, in particular less than the first wave trap resonant frequency and less than the second wave trap resonant frequency. This is particularly advantageous for a modular DC-DC converter, wherein the first frequency is greater than the series resonant frequency that arises from the mesh capacitor and the third inductor. This gives a particularly advantageous configuration if an inductive behavior is provided for the first frequency in the mesh circuit such that the series resonant frequency is less than the first wave trap resonant frequency. Correspondingly, the series resonant frequency is then also less than the second wave trap resonant frequency. Particularly good regulating behavior and controlling behavior can therefore be implemented for the DC-DC converter. At the same time, the effects of the alternating variables, in particular the effects of the AC voltage portion or the AC voltage portions and of the alternating current, can be kept away from the DC voltage terminals of the first and second DC voltage side to a particularly large extent. Then only the desired direct variables such as DC voltage and direct current are present at the DC voltage terminals of the first and second DC voltage side. Therefore, the components connected to the DC-DC converter are not affected. At the same time, any existing connection conditions for DC voltage grids and/or consumers can be fulfilled easily by a DC-DC converter of this type.

In a further advantageous configuration of the invention, the first number of submodules is greater than the second number of submodules. The proposed construction of the DC-DC converter can be dimensioned in a particularly simple manner. More submodules are then required on the overvoltage side than on the undervoltage side in order to apply a higher DC voltage. A construction of this type is particularly cost-effective to manufacture.

In a further advantageous configuration of the invention, the first module arm and/or the second module arm has a parallel circuit of submodules arranged in a series circuit. To achieve particularly good power scaling, the first module arm and/or the second module arm can have a parallel circuit of submodules or of a series circuit of submodules. Two or more series circuits of submodules are arranged in a parallel circuit. For good regulating behavior or controlling behavior, it has proven advantageous for the series circuits of submodules to each have an inductor. For better differentiation, this inductor can also be referred to as a module inductor. Using this module inductor, it is possible to control or regulate the distribution of the currents over the parallel series circuits in a simple manner. These inductors are then simultaneously parts of the third inductor. As a result, not only is simple control of the current distribution over the parallel series circuits ensured, but improvement in the regulating behavior for power exchange by means of the AC voltage portion is also achieved. The parallel circuit allows the modular DC-DC converter to be scaled in its performance in a simple manner using the same component parts such as submodules.

In a further advantageous configuration of the invention, the voltage level of the AC voltage portion, in particular the amplitude of the AC voltage portion with the first frequency, is less than the absolute value of the voltage of the DC voltage portion. The voltage level is the maximum absolute value of the voltage with which the alternating portion oscillates around its mean value. In the case of an alternating portion in which there is only one oscillation with one frequency, this is the amplitude of the oscillation. If this voltage level or the amplitude of the alternating portion is lower than the DC voltage portion, only one voltage with one polarity is applied at the module arm. In this case, half-bridge modules with one capacitor and two semiconductor switches can be used for the module arm, and these are particularly cost-effective and simple in terms of regulation and control.

In a further advantageous configuration of the invention, a phase difference is generated between the AC voltage portion with the first frequency of the first module arm and the AC voltage portion with the first frequency of the second module arm on the basis of the electrical power to be transmitted by the modular DC-DC converter and/or on the basis of the voltages of the module capacitors. If the phase difference between the AC voltage portions of the first module arm and of the second module arm are used as an actuating variable, it has been shown that particularly dynamic regulation of the DC-DC converter can be achieved, since the phase difference has a direct physical link to the active line exchange between the first DC voltage side and the second DC voltage side by means of the AC voltage portion and the alternating current.

In a further advantageous configuration of the invention, the voltage level of the DC voltage portion is generated on the basis of the electrical power to be transmitted by the DC-DC converter and/or on the basis of the voltages of the module capacitors. The voltage level of the DC voltage portion is the absolute value of the DC voltage portion. Using this regulation, it is possible to control or regulate the exchange of power between the first DC voltage side and the second DC voltage side in a higher-level power regulation in a particularly simple and cost-effective manner with little outlay. It has proven advantageous to control or regulate the DC voltage portion of only one of the two DC voltage sides by means of this method, while the other DC voltage side the voltage between the two respective DC voltage terminals is controlled or regulated.

In a further advantageous configuration of the invention, the voltage level of the DC voltage portion is controlled or regulated on the basis of the voltage between the DC voltage terminals of one of the DC voltage sides. For connecting a consumer to a DC voltage grid, it has proven advantageous to control or regulate the voltage between the DC voltage terminals of the DC voltage side to which the consumer is attached. In this case, the consumer is provided with the necessary operating voltage and can draw electrical energy from the DC voltage grid depending on the operating situation or can feed electrical energy back into this DC voltage grid as required.

In a further advantageous configuration of the invention, the voltage level of the AC voltage portion, in particular the amplitude of the AC voltage portion with the first frequency, and the phase difference between the AC voltage portion of the first module arm and the AC voltage portion of the second module arm are generated in such a way that a first electrical power from the AC voltage portion corresponds to a second electrical power from the DC voltage portion. The powers from the AC voltage portion and the power from the DC voltage portion differ only by the electrical losses. The power from the AC voltage portion means the active power that arises from the AC voltage portion of the voltage and the AC voltage portion of the current through the respective module arm. The power from the DC voltage portion means the active power that arises from the DC voltage portion of the voltage and the DC voltage portion of the current through the respective module arm. In this particularly simple manner, stable behavior of the modular DC-DC converter can be achieved over a longer period, i.e. over at least 10 cycle durations of the first frequency.

In the text that follows, the invention will be described and explained in more detail using the exemplary embodiments depicted in the drawings. It is shown in:

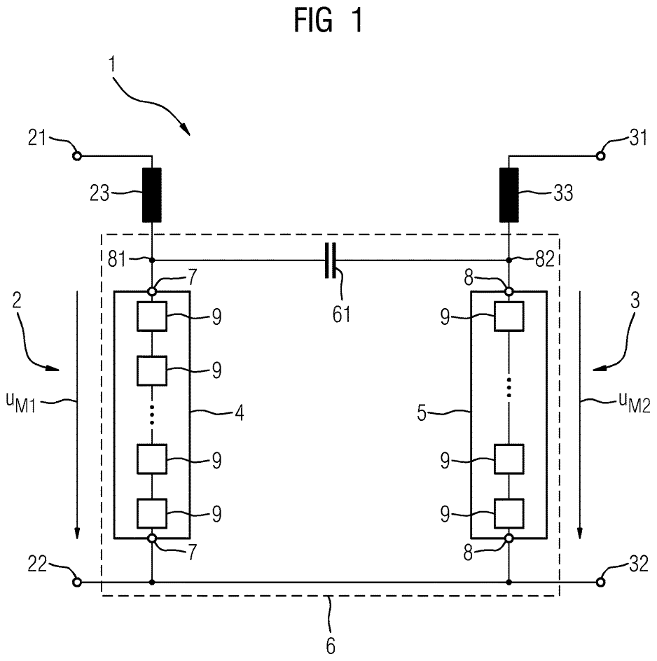

FIG. 1 to FIG. 4 exemplary embodiments of a modular DC-DC converter,

FIG. 5 a DC voltage grid, and

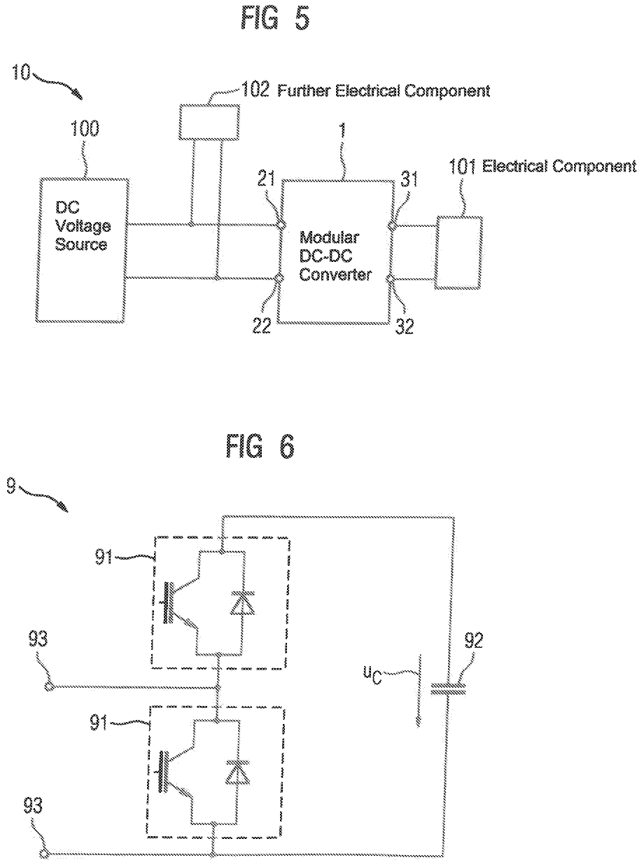

FIG. 6 to FIG. 8 exemplary embodiments of a submodule.

FIG. 1 shows a modular DC-DC converter 1. It has a first DC voltage side 2 with two first DC voltage terminals 21, 22 and a second DC voltage side 3 with two second DC voltage terminals 31, 32. A first module arm 4 and a first inductor 23 are arranged between the two first DC voltage terminals 21, 22. Furthermore, a second module arm 5 and a second inductor 33 are arranged between the two second DC voltage terminals 31, 32. The first module arm 4 has two first module arm terminals 7 and the second module arm 5 has two second module arm terminals 8. A series circuit of submodules 9 is arranged between the module arm terminals 7, 8 in each case. The number of submodules 9 can differ for both module arms 4, 5. The DC voltage side 2, 3 with the higher operating voltage preferably has a higher number of submodules arranged in series in the relevant module arm 4, 5. Therefore, if the operating voltage of the first DC voltage side 2 is greater than the operating voltage of the second DC voltage side 3, the number of submodules 9 of the first module arm 4 arranged in a series circuit is preferably greater than the number of submodules 9 of the second module arm 5 arranged in a series circuit.

As depicted, the first inductor 23 is connected directly to a first DC voltage terminal 21 of the two first DC voltage terminals 21, 22. Alternatively, the first inductor 23 is connected directly to a second DC voltage terminal 22 of the two first DC voltage terminals 21, 22. As depicted, the second inductor 33 is also connected directly to a first DC voltage terminal 31 of the two second DC voltage terminals 31, 32. Alternatively, the second inductor 33 is connected directly to a second DC voltage terminal 32 of the two second DC voltage terminals 31, 32.

The module arm terminals 7, 8 of the two module arms 4, 5 are each connected to one another via at least one mesh capacitor 61 in such a way that a mesh circuit 6 is formed. The first connecting point 81 represents a point in the mesh circuit 6 between the mesh capacitor 61 and the first module arm 4. The second connecting point 82 represents a point in the mesh circuit 6 between the mesh capacitor 61 and the second module arm 5. The respective connecting points 81, 82 are each connected to the first terminal 21, 31 of the first DC voltage terminals 21, 22 or second DC voltage terminals 31, 32 directly or via the first or second inductor 23, 33.

The voltage u_{M1} is generated across the series circuit of submodules 9 of the first module arm 4, which voltage u_{M1} is composed of the sum of a DC voltage portion and at least one AC voltage portion. The voltage u_{M2} is generated across the series circuit of submodules 9 of the second module arm 5, which voltage u_{M2} is composed of the sum of a DC voltage portion and at least one AC voltage portion.

The first inductor 23 and the second inductor 33 are arranged outside the mesh circuit 6.

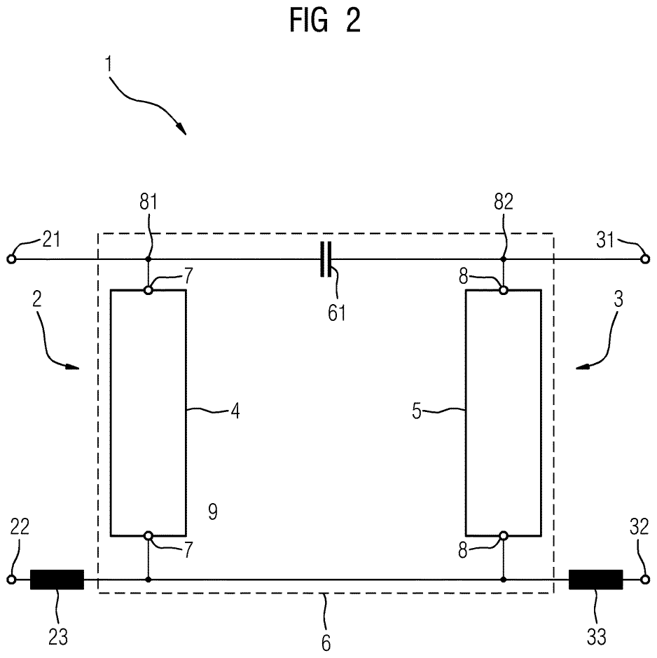

FIG. 2 shows a further exemplary embodiment of the modular DC-DC converter 1. To avoid repetition, reference is made to the description in relation to FIG. 1 and to the reference signs introduced there. In contrast to the exemplary embodiment in FIG. 1, the first inductor 23 is now connected to a second DC voltage terminal 22 of the two first DC voltage terminals 21, 22. The first connecting point 81 is then connected directly to the first DC voltage terminal 21 of the two first DC voltage terminals 21, 22. The second connecting point 82 is then connected directly to the first DC voltage terminal 31 of the two second DC voltage terminals 31, 32. Alternatively, it is also possible for the first inductor 23 to be split. One part of the first inductor 23 is connected to the first DC voltage terminal 21 of the two first DC voltage terminals 21, 22 and a further part of the first inductor 23 is connected to the second DC voltage terminal 22 of the two first DC voltage terminals 21, 22. Alternatively, it is similarly possible for the second inductor 33 to be split. One part of the second inductor 33 is connected to the first DC voltage terminal 31 of the two second DC voltage terminals 31, 32 and a further part of the second inductor 33 is connected to the second DC voltage terminal 32 of the two second DC voltage terminals 31, 32. This then represents a combination of the exemplary embodiments in FIGS. 1 and 2.

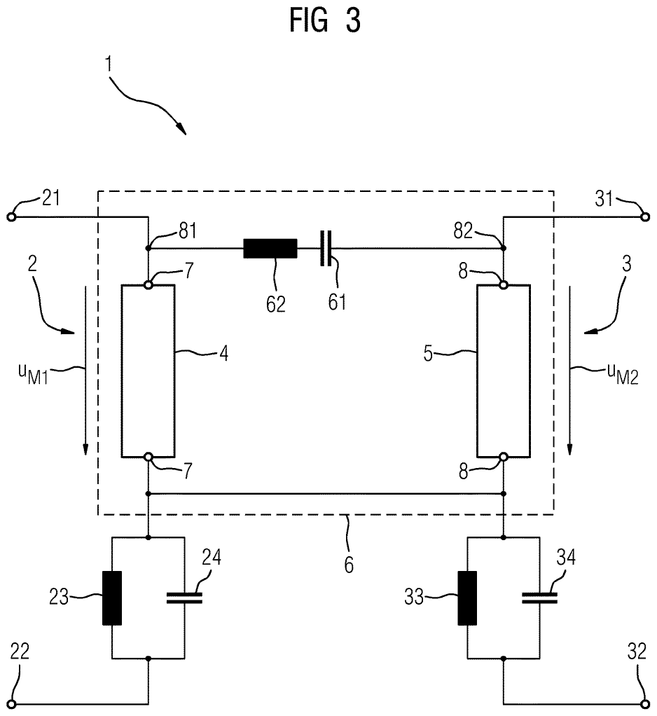

FIG. 3 shows a further exemplary embodiment of the modular DC-DC converter 1. Starting from one of the exemplary embodiments in FIGS. 1 and 2, a third inductor 62 is arranged in the mesh circuit 6. To avoid repetition, reference is made to the description in relation to FIGS. 1 and 2, and to the reference signs Introduced there. The third inductor 62 can form, as depicted, a series circuit with the mesh capacitor 61, for example. Alternatively, an arrangement of the third inductor 62 at every other point in the mesh circuit 6 is also possible. Together with the mesh capacitor, the third inductor 62 forms a series resonance circuit in the mesh circuit 6.

The third inductor is preferably designed such that inductive behavior is induced in the series resonance circuit for the AC voltage portion with the first frequency. This means that the alternating current in the mesh circuit 6 can be controlled or regulated particularly advantageously. At the same time, the formation of a direct current between the two DC voltage sides 2, 3 is reliably avoided.

A first wave trap capacitor 24 is arranged in parallel with the first inductor 23. A second wave trap capacitor 34 is likewise arranged in parallel with the second inductor 33. These each form wave traps, which reliably prevents or at least sufficiently suppresses formation of an alternating current, in particular caused by the AC voltage portion of the module arms at the DC voltage terminals 21, 22, 31, 32.

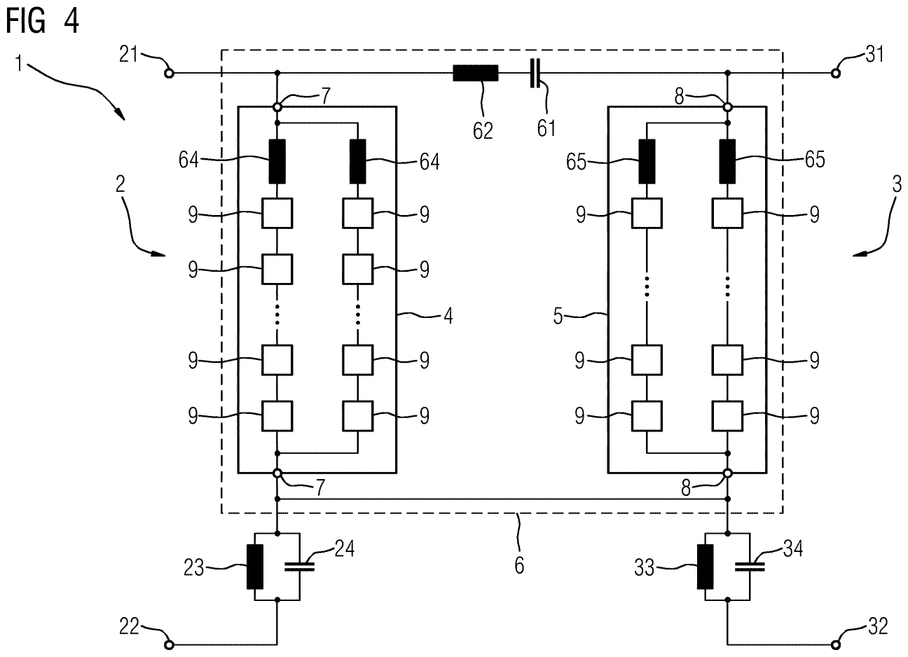

FIG. 4 shows a further exemplary embodiment of the modular DC-DC converter 1. Starting from one of the exemplary embodiments in FIGS. 1 to 3, the my third inductor 62 are arranged in the mesh circuit 6. To avoid repetition, reference is made to the description in relation to FIGS. 1 to 3, and to the reference signs introduced there. In this exemplary embodiment, the module arms 4, 5 each have a parallel circuit of submodules 9 arranged in a series circuit. To be able to better control or regulate the current distribution over the parallel branches, the series circuits each have a module arm inductor 64, 65, The inductors in the first module arm 4 are referred to as first module arm inductors 64 and the inductors in the second module arm 5 are referred to as second module arm inductors 65.

As an alternative to the depicted exemplary embodiment, it is also possible for only one of the module arms 4, 5 to have a parallel circuit of submodules 9 arranged in a series circuit. If the second DC voltage side 3 has a lower operating voltage than the first DC voltage side 2, it is advantageous, due to the higher currents at the second DC voltage terminals 31, 32 in comparison with the first DC voltage terminals 21, 22, if only the second module arm 5 has a parallel circuit of submodules 9 arranged in a series circuit.

FIG. 5 shows an exemplary embodiment of a DC voltage grid 10 with a modular DC-DC converter 1 that can be designed according to one of FIGS. 1 to 4, for example.

In the DC voltage grid 10, an electrical component 101 is connected to a DC voltage source 100 of the DC voltage grid via the modular DC-DC converter 1. This can happen, for example, when the operating voltages of the DC voltage source 100 and the electrical component 101 differ. An arrangement of this type is also useful if the exchange of energy between DC voltage source 100 and electrical component 101 at the same operating voltage or a different operating voltage is to be controlled or regulated. The control or regulation can be implemented by the modular DC-DC converter 1. The DC voltage grid can have a plurality of electrical components which are supplied with electrical energy from a DC voltage source 100 via a modular DC-DC converter 1. Each electrical component can be connected to the DC voltage source 100 via a separate modular DC-DC converter 1. Alternatively, it is also possible to connect several electrical components 101 to a modular DC-DC converter 1.

In addition to the electrical components 101 mentioned, which are connected to the DC voltage source 100 of the DC voltage grid 10 via a modular DC-DC converter 1, the DC voltage grid can have further electrical components 102 which are connected to the voltage source 100 directly, that is, without the modular DC-DC converter 1.

The electrical component 101 and/or further electrical component 102 can also be sub-grids which have a plurality of electrical sources and consumers.

FIG. 6 shows a first exemplary embodiment of a submodule 9. The submodule 9, also referred to as half-bridge module, has two semiconductor switches 91 and a capacitor 92. The zero voltage or the capacitor voltage uc can be applied between the terminals 93 of the submodule 9 by means of switching operations of the semiconductor switches 91.

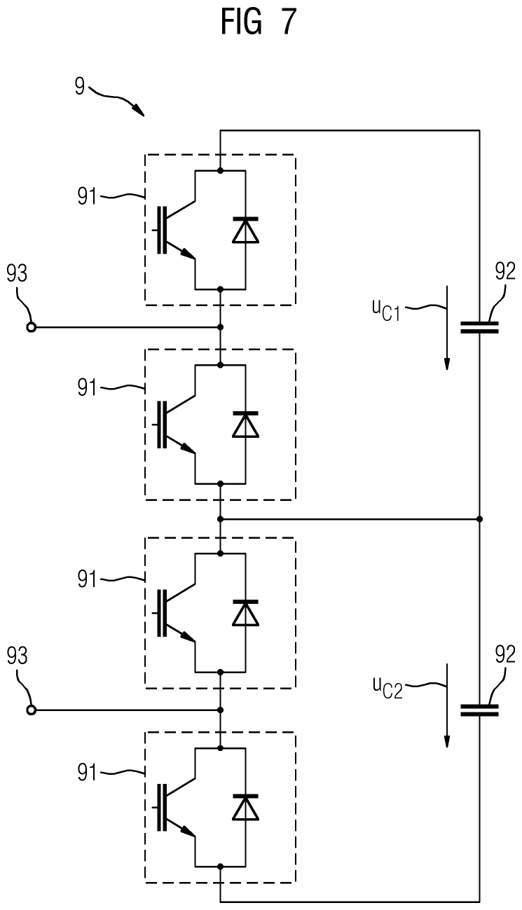

FIG. 7 shows a further exemplary embodiment of a submodule 9. The submodule 9, also referred to as double half-bridge module, has four semiconductor switches 91 and two capacitors 92. The zero voltage or the voltage of one or both capacitors 92 can be applied between the terminals 93 of the submodule 9 by means of switching operations of the semiconductor switches 91.

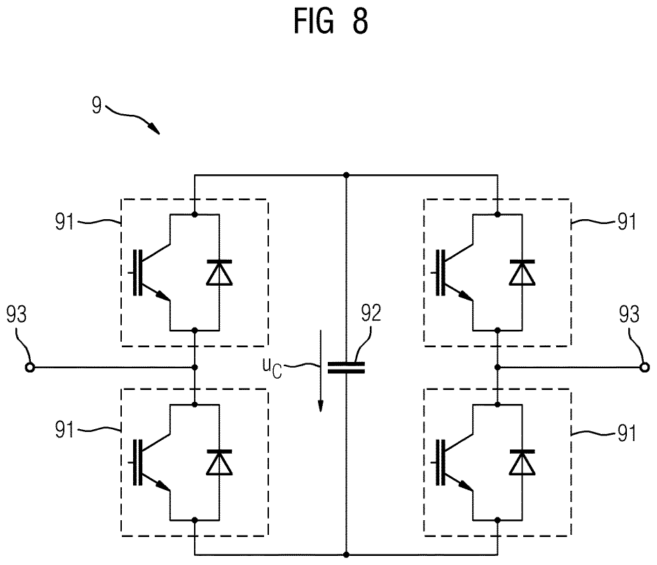

FIG. 8 shows a further exemplary embodiment of a submodule 9. The submodule 9, also referred to as full-bridge module, has four semiconductor switches 91 and a capacitor 92. The zero voltage or the positive or negative voltage uc of the capacitor 92 can be applied between the terminals 93 of the submodule 9 by means of switching operations of the semiconductor switches 91.

It should be noted that the exemplary embodiments and the advantages mentioned in particular for meeting specified requirements can be combined with one another as desired.

In summary, the invention relates to a modular DC-DC converter 1 having a first DC voltage side 2 with two first DC voltage terminals 21, 22, a second DC voltage side 3 with two second DC voltage terminals 31, 32, a first module arm 4 with two first module arm terminals 7 and a second module arm 5 with two second module arm terminals 8. The first module arm 4 and a first inductor 23 are arranged in series between the two first DC voltage terminals 21, 22, wherein the second module arm 5 and a second inductor 33 are arranged in series between the two second DC voltage terminals 31, 32, wherein the first module arm 4, the second module arm 5 and a mesh capacitor 61 are arranged in series in such a way that a mesh circuit 6 is formed, wherein the module arms 4, 5 are each designed to generate a voltage u_{M1}, u_{M2} having a DC voltage portion and an AC voltage portion with a first frequency f₁. The invention further relates to a DC voltage grid 10 with a DC-DC converter 1 of this type. Furthermore, the invention relates to a method for operating a modular DC-DC converter 1 of this type or a DC voltage grid 10 of this type.

1.-18. (canceled)

19. A modular DC-DC converter, comprising:
a first DC voltage side including two first DC voltage terminals;
a second DC voltage side including two second DC voltage terminals;
a first inductor;
a first module arm including two first module arm terminals and arranged in series with the first inductor between the two first DC voltage terminals, said first module arm being designed to generate a voltage having a DC voltage portion and an AC voltage portion with a first frequency;
a first number of submodules arranged in a series circuit between the two first module arm terminals of the first module arm;
a second inductor;
a second module arm including two second module arm terminals and arranged in series with the second inductor between the two second DC voltage terminals, said second module arm being designed to generate a voltage having a DC voltage portion and an AC voltage portion with the first frequency;
a second number of submodules arranged in a series circuit between the two second module arm terminals of the second module arm;
a mesh capacitor arranged in series with the first module arm and the second module arm in such a way as to form a mesh circuit, with the first inductor and the second inductor being each arranged outside the mesh circuit;
wherein the submodules of the first number of submodules and the second number of submodules each comprise at least two semiconductor switches and at least one module capacitor, and
wherein the modular DC-DC converter is designed to control or regulate a direct current on the first DC voltage side via the DC voltage portion of the first module arm and to control or regulate a direct current on the second DC voltage side via the DC voltage portion of the second module arm.

20. The modular DC-DC converter of claim 19, wherein the modular DC-DC converter is designed to transmit electrical energy between the first DC voltage side and the second DC voltage side via the AC voltage portion.

21. The modular DC-DC converter of claim 19, further comprising a third inductor arranged in the mesh circuit.

22. The modular DC-DC converter of claim 21, wherein the first frequency is greater than a series resonant frequency that arises from the mesh capacitor and the third inductor.

23. The modular DC-DC converter of claim 21, wherein the third inductor is formed at least partially by a first module arm inductor in the first module arm and a second module arm inductor in the second module arm.

24. The modular DC-DC converter of claim 19, further comprising a first wave trap capacitor arranged in parallel with the first inductor or with part of the first inductor and/or a second wave trap capacitor arranged in parallel with the second inductor or part of the second inductor.

25. The modular DC-DC converter of claim 24, wherein the first wave trap capacitor is arranged in parallel with the first inductor and the second wave trap capacitor is arranged in parallel with the second inductor, wherein a first wave trap resonant frequency, which arises from the parallel circuit of the first inductor and the first wave trap capacitor, is of a same order of magnitude as a second wave trap resonant frequency which arises from the parallel circuit of the second inductor and the second wave trap capacitor.

26. The modular DC-DC converter of claim 25, wherein the first wave trap resonant frequency is identical or at least almost identical to the second wave trap resonant frequency.

27. The modular DC-DC converter of claim 25, wherein the first frequency is greater than a series resonant frequency that arises from the mesh capacitor and a third inductor arranged in the mesh circuit, wherein the series resonant frequency is less than at least one of the first or second wave trap resonant frequencies.

28. The modular DC-DC converter of claim 27, wherein the series resonant frequency is less than the first wave trap resonant frequency and is less than the second wave trap resonant frequency.

29. The modular DC-DC converter of claim 19, wherein the first number of submodules is greater than the second number of submodules.

30. The modular DC-DC converter of claim 19, wherein at least one of the first and second module arms has a parallel circuit of submodules arranged in a series circuit.

31. A DC voltage grid, comprising:
a DC voltage source; and
the modular DC-DC converter of claim 19, designed to electrically connect an electrical component to the voltage source,
wherein the DC voltage source and the electrical component have different operating voltages.

32. A method for operating the modular DC-DC converter of claim 19 or a DC voltage grid comprising a DC voltage source and the modular DC-DC converter which is designed to electrically connect an electrical component to the voltage source, with the DC voltage source and the electrical component having different operating voltages, the method comprising:
the first module arm and the second module arm each generating a voltage with a DC voltage portion and an AC voltage portion with a first frequency;
superimposing the DC voltage portion and the AC voltage portion in such a way that the DC voltage portion and the AC voltage portion are applied as a sum between the module arm terminals of the corresponding one of the first and second module arms;
the DC voltage portion of the first module arm controlling or regulating a direct current on the first DC voltage side; and
the DC voltage portion of the second module arm controlling or regulating a direct current on the second DC voltage side.

33. The method of claim 32, further comprising transmitting electrical energy between the first DC voltage side and the second DC voltage side via the AC voltage portion.

34. The method of claim 32, wherein a voltage level of the AC voltage portion, in particular an amplitude of the AC voltage portion with the first frequency, is less than an absolute value of a voltage of the DC voltage portion.

35. The method of claim 32, further comprising generating a phase difference between the AC voltage portion with the first frequency of the first module arm and the AC voltage portion with the first frequency of the second module arm based on an electrical power to be transmitted by the modular DC-DC converter and/or based on a voltage of the at least one module capacitor.

36. The method of claim 32, further comprising generating a voltage level of the DC voltage portion based on an electrical power to be transmitted by the modular DC-DC converter and/or based on a voltage of the module capacitor.

37. The method of claim 32, further comprising controlling or regulating a voltage level of the DC voltage portion based on a voltage between the DC voltage terminals of one of the first and second DC voltage sides.

38. The method of claim 32, further comprising generating a voltage level of the AC voltage portion, in particular an amplitude of the AC voltage portion with the first frequency, and a phase difference between the AC voltage portion of the first module arm and the AC voltage portion of the second module arm in such a way that a first electrical power from the AC voltage portion corresponds to a second electrical power from the DC voltage portion.
